(19) United States
(12) Patent Application Publication
(10) Pub. No.: US 2025/0203221 A1
(43) Pub. Date: Jun. 19, 2025

(54) IMAGE PROCESSING DEVICE, VISION SYSTEM, AND IMAGE PROCESSING PROGRAM

(71) Applicant: FANUC CORPORATION, Yamanashi (JP)

(72) Inventor: Yuuki TAKAHASHI, Yamanashi (JP)

(21) Appl. No.: 18/847,684

(22) PCT Filed: May 16, 2022
(86) PCT No.: PCT/JP2022/020421

§ 371 Date: Sep. 17, 2024

(51) Int. Cl. H04N 23/75; G06T 1/00; G06T 7/70; H04N 23/67; H04N 23/72; H04N 23/74

(52) U.S. Cl. CPC H04N 23/75; G06T 1/0014; G06T 7/70; H04N 23/67; H04N 23/72; H04N 23/74; G06T 2207/30164

(57) ABSTRACT

An image processing device comprises an aperture control unit that obtains, on the basis of image information from an image capture device that has a lens and captures an image of an object, spatial position information of the object and controls the aperture of the lens. When the distance from the image capture device to the object is a first distance, the image capture device captures an image of the object to obtain a first image with the focus position for the lens adjusted and fixed, and with the aperture of the lens set to a first aperture by the aperture control unit. When the distance from the image capture device to the object is a second distance, the image capture device captures an image of the object to obtain a second image with the aperture of the lens set to a second aperture by the aperture control unit.

### RELATED APPLICATIONS

The present application is a National Phase of International Application No. PCT/JP2022/020421 filed May 16, 2022.

### FIELD

Embodiments discussed herein relate to an image processing device, a vision system, and an image processing program.

### BACKGROUND

In recent years, a vision system (machine vision, robot vision) has been applied to an industrial machine, or an industrial robot or a cooperative robot, and a predetermined operation is performed on the industrial machine or the like based on an image obtained by the vision system.

For example, in an industrial robot to which the robot vision is applied, based on image information obtained by capturing a target object (workpiece) with an image capturing device (camera), the industrial robot is controlled to execute a predetermined process on the workpiece.

Note that, in this specification, for simplifying explanations, a robot vision of an industrial robot will be described as a vision system to which an image processing device is applied. However, the image processing device, the vision system, and the image processing program according to the present embodiment are not limited to the industrial robot and the robot vision, and may be widely applied to various machines and robots, and the like.

Further, in this specification, the term “vision system” means a system that controls various machines based on image capturing and processing operations, and includes all industrial and non-industrial applications that combine hardware and software.

Conventionally, various proposals have been made for robot vision of an industrial robot, or a control technique of a camera used in a vision system.

### CITATION LIST

### Patent Literature

[PTL 1] Japanese Unexamined Patent Publication (Kokai) No. 2019-113680
[PTL 2] Japanese Unexamined Patent Publication (Kokai) No. 2019-161553
[PTL 3] Japanese Unexamined Patent Publication (Kokai) No. 2006-253998

### SUMMARY

### Technical Problem

As described above, for example, in the industrial robot to which the robot vision is applied, it has been known that spatial position information is obtained from image information of a workpiece captured by a camera, and the industrial robot is controlled to execute a predetermined process on the workpiece.

Note that a fixed-focus camera has been generally used as the camera in such a robot vision, however, in recent years, a camera with a focus function (for example, autofocus camera) has also been utilized.

Incidentally, robot vision using the fixed-focus camera does not require adjustment of a focus position, and therefore, it is not necessary to change parameters used in conversion equations for converting the image information of the workpiece into spatial position information.

On the other hand, robot vision using the camera with a focus function may capture a sharp image by focusing based on a position of the camera with respect to a workpiece (distance between the workpiece and the camera). However, for example, when adjusting the focus position, it is necessary to change parameters used in conversion equations for converting the image information obtained by capturing an image of the workpiece into the spatial position information in each time.

Specifically, since it is necessary to change the parameters used in the conversion formula when the focus position (focal length) of a lens is changed, the parameters used in the conversion equations should be changed. Therefore, it may be necessary to previously provide parameters used in the conversion equations corresponding to each of the focus positions.

As a result, there is a risk that processing for capturing the image of the workpiece (object) may become complicated, or that processing for obtaining a spatial position of the object may take a long time. Furthermore, since a focus operation of the lens of the camera (image capturing device) may be performed by, for example, a driving unit which changes a positional relationship of the lens. Therefore, errors in the position of the lens may be easily caused, and accuracy of converting the image information into the spatial position information of the object may be reduced.

The problem to be solved by the present invention is to provide an image processing device, a vision system, and an image processing program capable of performing image processing for obtaining spatial position information of an object based on image information in a short time and with high accuracy.

### Solution to Problem

According to an embodiment of the present invention, there is provided an image processing device for obtaining spatial position information of an object based on image information output from an image capturing device including a lens configured to capture an image of the object. The image processing device includes an aperture control unit configured to control an aperture of the lens. When a distance from the image capturing device to the object is a first distance, a focus position of the lens is adjusted and fixed, the aperture control unit sets the aperture of the lens to a first aperture, and the image capturing device captures the object to obtain a first image, when a distance from the image capturing device to the object is a first distance. When the distance from the image capturing device to the object is a second distance, the aperture control unit sets the aperture of the lens to a second aperture, and the image capturing device captures the object to obtain a second image.

The objects and effects of the present invention will be recognized and obtained by using the components and combinations pointed out in the claims. Both the general description described above and the detailed description below are exemplary and descriptive and do not limit the invention described in the claims.

### BRIEF DESCRIPTION OF DRAWINGS

FIG. 1 is a block diagram depicting an industrial robot system as an example to which an image processing device according to the present embodiment is applied.

FIG. 2 is a diagram for explaining parameters of conversion equations used to obtain spatial position information of an object based on image information output from the image capturing device depicted in FIG. 1.

FIG. 3 is a diagram for explaining a relationship between an aperture of a lens and a depth of field in the industrial robot system depicted in FIG. 1.

FIG. 4A and FIG. 4B are diagrams depicting an example of a lighting device used in the industrial robot system depicted in FIG. 1.

FIG. 5 is a block diagram depicting a vision system to which an example of the image processing device according to the present embodiment is applied.

FIG. 6 is a flowchart for explaining an example of processing of an image processing program executed by a processing unit (arithmetic processing unit) of the image processing device depicted in FIG. 5.

### DESCRIPTION OF EMBODIMENTS

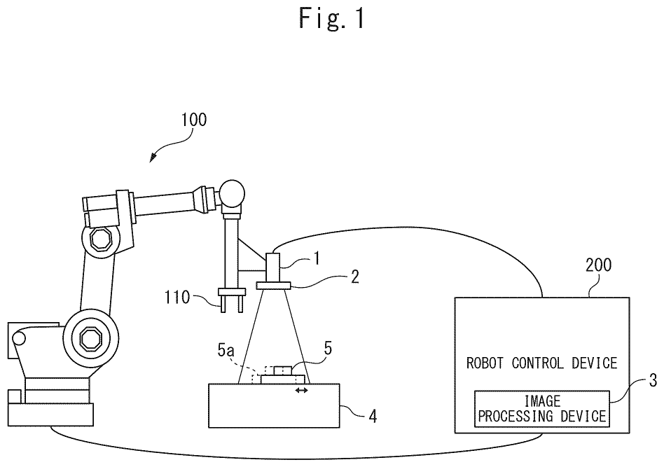

First, an example of an industrial robot system to which an image processing device according to the present embodiment is applied will be explained with reference to FIG. 1 to FIG. 4B, before an image processing device, a vision system, and an image processing program according to the present embodiment will be described in detail. FIG. 1 is a block diagram depicting an industrial robot system as an example to which an image processing device according to the present embodiment is applied.

In FIG. 1, reference numeral 100 denotes an industrial robot, 110 denotes a hand unit, 200 denotes a robot control device, and 3 denotes an image processing device. Further, reference numeral 1 denotes an image capturing device (camera), 2 denotes a lighting device (ring lighting), 4 denotes a workbench, and 5 denotes an object (workpiece). Note that a robot vision (vision system) is, for example, constituted by including the camera 1, the lighting device 2, and the image processing device 3.

FIG. 1 depicts a case where the hand unit 110 of the industrial robot 100 is moved according to a teaching route, which is previously set to operate the hand unit 110 for grasping a workpiece 5. Here, in FIG. 1, a position of the workpiece 5 placed on the workbench 4 is deviated from an original position (position based on the teaching route) 5a indicated by a dashed line.

Specifically, FIG. 1 depicts a case where the hand unit 110 is moved according to a preset teaching route and the workpiece 5 placed on the workbench 4 is grasped by the hand unit 110, however, an actual spatial position of the workpiece 5 on the workbench 4 is deviated from an assumed original position 5a. Here, the camera 1 and the lighting device 2 are attached to the vicinity of hand unit 110 of the industrial robot 100 and moved together with the hand unit 110, so that the workpiece 5 placed on the workbench 4 may be captured by the camera 1.

At this time, the image processing device 3 obtains actual spatial position information of the workpiece 5 based on image information of the workpiece 5 on the workbench 4, which is captured by the camera 1, and detects a deviation from an assumed position 5a. Further, the image processing device 3 recognizes and corrects the deviation between the assumed position 5a and the actual spatial position of the workpiece 5 via the robot control device 200, and controls the hand unit 110 to correctly grasp the workpiece 5.

In this way, by applying the robot vision to the industrial robot system, for example, even when a position of the workpiece 5 on the workbench 4 is deviated, the deviation may be corrected and the industrial robot 100 may perform a correct operation. In FIG. 1, the image processing device 3 is provided in the robot control device 200, but it may also be provided outside the robot control device 200 as a separate body.

Here, in the industrial robot system depicted in FIG. 1, the workpiece 5 is placed on the workbench 4, and the camera 1 is attached close to the hand unit 110 (actuator) of the industrial robot 100 to move together. Note that the image processing device 3 according to this embodiment may be widely applied to various machines and robots or the like in which at least one of the camera 1 and the workpiece 5 is grasped by a movement controllable actuator.

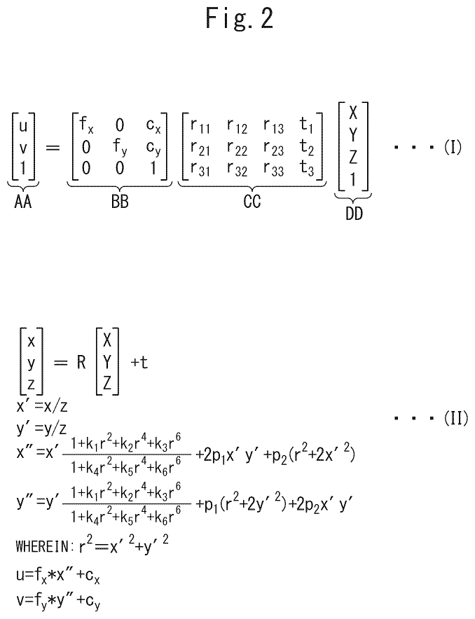

FIG. 2 is a diagram for explaining parameters of conversion equations used to obtain spatial position information of an object based on image information output from the image capturing device depicted in FIG. 1. In FIG. 2, equation (I) is a relational equation between a spatial position and a position on an image by projecting three-dimensional coordinates in a so-called pinhole camera model onto an image plane by using a perspective projection transformation. Further, equation (II) is an extended relational equation in consideration of distortions of an actual lens of the camera 1 in a radial direction, a circumferential direction, and the like.

In the equation (I), reference sign AA represents a position on an image (position of a workpiece 5 in an image captured by the camera 1), BB represents a focal length and an image center of the camera 1, CC represents camera coordinates in a space, and DD represents a spatial position (position of the workpiece 5 in an actual space). Here, reference signs (X, Y, Z) represent 3D coordinates in a world coordinate system, (u, v) represent coordinates of a point projected onto an image plane, (cx, cy) represent principal points (usually an image center), and fx, fy represent focal lengths expressed in pixels.

In the equation (II), reference sign t represents [t₁, t₂, t₃], R represents an r matrix of 3×3, and k₁ to k₆, and p₁, p₂ represent parameters. Therefore, the position of the workpiece 5 in the actual space may be obtained by converting the position of the workpiece 5 in the image captured by the camera 1 based on the equation (II). At this time, by preparing in advance the camera coordinates CC in the space, the focal length and the image center BB, and the distortion parameters (k₁ to k₆ and p₁, p₂: 6 kinds of k and 2 kinds of p), it may be possible to obtain the spatial position DD from the position AA on the image.

Here, when changing a focus position of the lens, a focal length f is changed in accordance with each time of changing the focus position, and therefore, the parameters (6 kinds of k and 2 kinds of p) corresponding to the focal length f may be necessary to obtained in advance. Specifically, in a vision system using a camera including a focus function, it is necessary to change parameters used in conversion equations when a focus position (focal length) of a lens changes.

As described above, when using the camera including the focus function, it is necessary to obtain parameters corresponding to the focus position at the time of imaging the workpiece in advance, so that the processing when imaging the workpiece becomes complicated, or the processing may lead to problems such as prolonged. Further, since a focus of the lens is performed by the driving unit for changing the position of the lens, errors in the position of the lens may be easily caused, so that a problem of decreasing an accuracy of converting the spatial position information of the workpiece from the image information may also be caused.

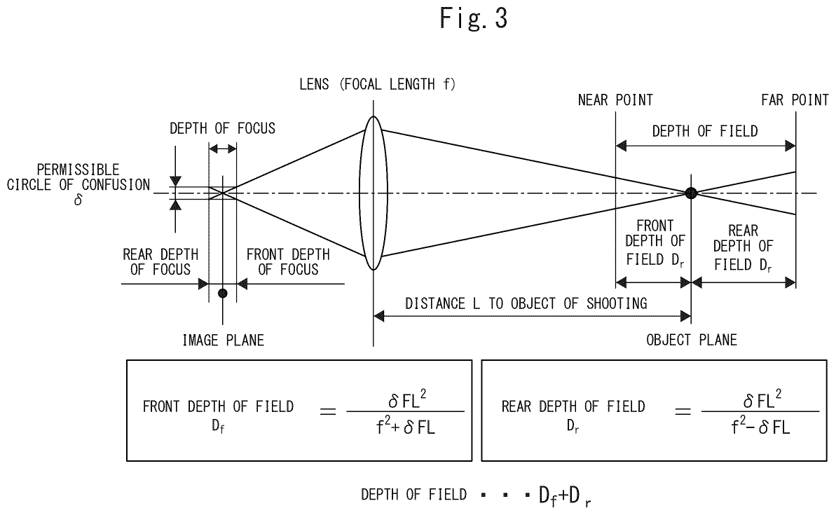

FIG. 3 is a diagram for explaining a relationship between an aperture of a lens and a depth of field in the industrial robot system depicted in FIG. 1, and for explaining the relationship between an aperture (aperture value, aperture amount) and the depth of the field of a camera 1. In FIG. 3, reference symbol L represents a distance to an object of shooting (workpiece 5), δ represents a permissible circle of confusion (constant determined by resolution), f represents a focal length, and F represents an aperture amount (aperture value).

Note that a depth of field D represents a range in focus, and is determined by the sum of a front depth of field Df and a rear depth of field Dr: (D=Df+Dr), where Df and Dr are expressed as follows:

$$\begin{matrix}Df = ( δ {FL}^{2} ) / ( {f}^{2} + δ FL ) \\ Dr = ( δ {FL}^{2} ) / ( {f}^{2} - δ FL )\end{matrix}$$

Here, under the condition where f, 8 and L are constant, when the aperture amount F is increased, the depth of field D increases (deepens), and an amount of light incident on an image element (CMOS (Complementary Metal Oxide Semiconductor) or CCD (Charge Coupled Device) image sensor) is decreased. Specifically, the amount of light incident on the image sensor may be expressed as C/F², where F is an aperture amount and C is a constant. Therefore, for example, when the aperture amount F is doubled, the amount of light incident on the image sensor becomes ¼.

Incidentally, there is provided a method of adjusting an exposure time of an image to adjust a brightness of the image, and wherein, when the exposure time is doubled, an image with twice the brightness may be obtained. Therefore, it may be considered that a depth of field D of the lens is increased by increasing the aperture amount F of the lens, or by widening a focus range of the lens (in-focus range), in accordance with compensating a reduction of an incident light intensity by increasing the exposure time.

Specifically, for example, in the case when the aperture amount F of the lens is doubled to deepen the depth of field D of the lens, an image with the same brightness may be obtained by increasing the exposure time to four times. Note that the exposure time t is represented by t=t₀×(F/F₀)², wherein to represents an exposure time before changing F, F₀ represents an aperture amount before changing F, and F represents an aperture amount after changing.

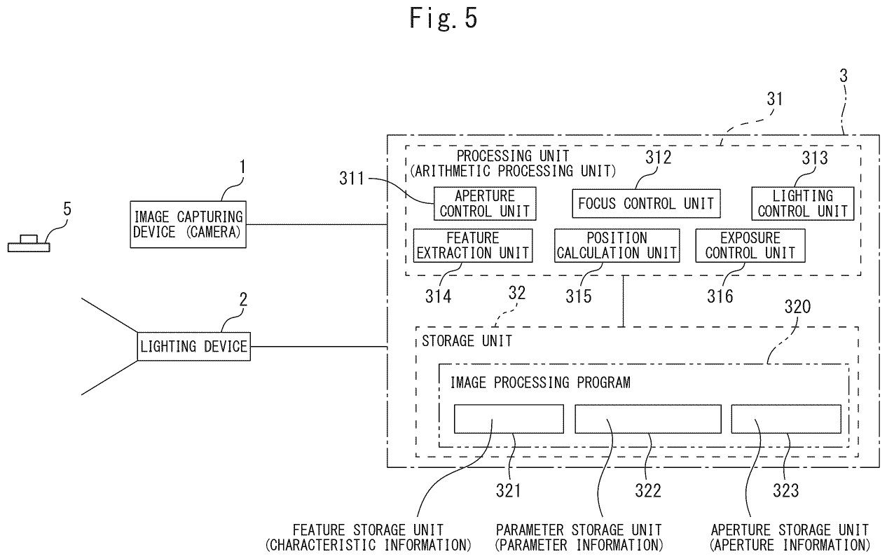

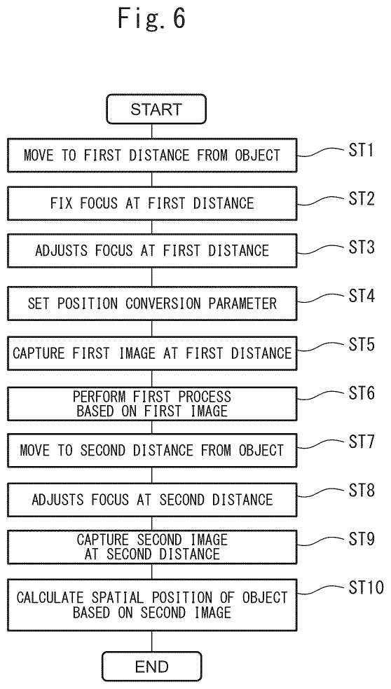

As will be described in detail later with reference to FIG. 5 and FIG. 6, in an example of an image processing device according to the present embodiment, when a distance of a camera 1 to a workpiece 5 is a first distance, a focus control unit 312 adjusts and fixes a focus position of a lens. Further, an aperture control unit 311 controls and sets an aperture of the lens to a first aperture, and a first image is obtained by capturing the workpiece 5.

Further, when the distance of the camera 1 to the workpiece 5 is a second distance, the focus position of the lens is fixed as it is, and the aperture control unit 311 sets the aperture of the lens to a second aperture, so that the workpiece 5 is included in a depth of field (D=Df+Dr). Specifically, when the distance between the workpiece 5 and the camera 1 is at the second distance, the workpiece 5 is focused (in focus) by the depth of field of the lens whose aperture is adjusted as the second aperture, and the workpiece 5 is captured at the second distance.

As described above, in the example of the image processing device of the present embodiment, for example, the focus position of the lens is fixed at both the first distance and the second distance where the distance between the camera 1 and the workpiece 5 is different, and the aperture of the lens is adjusted at the second distance. Therefore, the first image and the second image of the workpiece 5 may be obtained at both the first distance and the second distance which are different distances between the camera 1 and the workpiece 5.

In this way, when the focus position of the lens including a focus function is changed, it is necessary to change parameters based on the focus position, however, in the present embodiment, the focus positions of the first and second distances are be fixed, and therefore no parameter changes may be necessary. Specifically, when capturing both the first distance for capturing the first image and the second distance for capturing the second image, there is no need to prepare new parameters and the same parameters may be used therein. Therefore, according to the image processing device, the vision system and the image processing program of the present embodiment, it may be possible to perform image processing for obtaining spatial position information of an object 5 based on image information in a short time and with high accuracy.

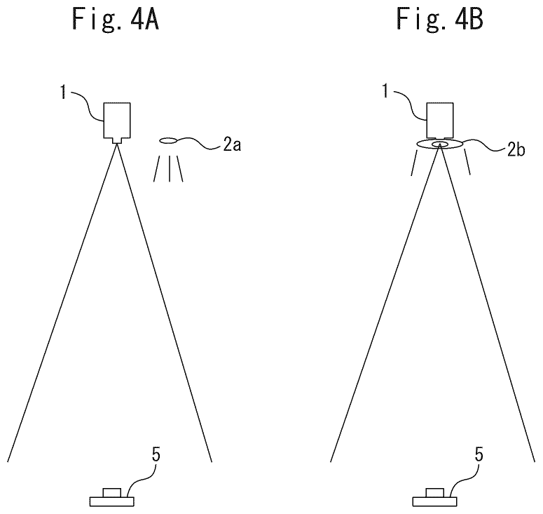

FIG. 4A and FIG. 4B are diagrams depicting an example of a lighting device used in the industrial robot system depicted in FIG. 1, wherein FIG. 4A depicts a circular lighting device 2a as an example of the lighting device 2, and FIG. 4B depicts a ring lighting device 2b as another example of the lighting device 2.

As depicted in FIG. 4A, the lighting device 2 may be, for example, the circular lighting device 2a provided in the vicinity of the camera 1. Nevertheless, as depicted in FIG. 4B, the lighting device 2 may be, for example, the ring lighting device 2b provided on an outer circumference of the lens of the camera 1.

Here, the circular lighting device 2a and the ring lighting device 2b may always irradiate a constant amount of irradiation light, however, they may be capable of controlling an intensity of the irradiation light, which will be described in detail later. Specifically, when the distance between the workpiece 5 and the camera 1 is the second distance, the lighting device 2 (2a, 2b) may increase the intensity of the irradiation light by increasing an aperture amount (aperture value) to compensate a reduced exposure amount and focus on the workpiece 5. Concretely, for example, when an aperture amount F is doubled to deepen the depth of field of the lens, the lighting control unit 313 adjusts the intensity of the irradiation light from the lighting device 2 to four times, so that it is possible to obtain a captured image with the same brightness.

Note that the lighting device 2 is not limited to the circular lighting device 2a and the ring lighting device 2b, but various lighting devices may be applied thereto. Further, it is needless to say, that numbers and locations of the lighting devices are not limited to provide only one lighting device close to the camera 1.

Here, the workpiece 5 is illuminated with the irradiation light from the lighting device 2 (circular lighting device 2a and the ring lighting device 2b), and when determining a distance from the camera 1 to the workpiece 5 at r, and a constant value at C, relationship C/r² is obtained. Therefore, as described above, when the aperture (F) of the lens is doubled, an amount of light incident into the camera 1 becomes ¼.

Further, considering the relationship with the aperture (t=t₀×(F/F₀)²), an exposure time t may be expressed as t=t₀×(F/F₀)²×(r/r₀)². Here, reference to represents an exposure time before changing an aperture of the lens, F₀ represents an aperture before changing the aperture of the lens, F represents an aperture after changing the aperture of the lens, r represents a distance before changing the aperture of the lens, and r₀ represents a distance after changing the aperture of the lens, Specifically, in order to compensate the exposure, there are a technique for adjusting the exposure time of the image, and a technique for adjusting the intensity of the irradiation light by the lighting device.

Hereinafter, examples of an image processing device, a vision system, and an image processing program according to the present embodiment will be described in detail with reference to the accompanying drawings.

FIG. 5 is a block diagram depicting a vision system to which an example of the image processing device according to the present embodiment is applied. Here, the vision system to which an embodiment of the image processing device according to the present embodiment is applied corresponds to, for example, a robot vision of an industrial robot system described with reference to FIG. 1. Note that the image processing device 3 may be incorporated in the robot control device 200 for controlling the industrial robot 100, but may be provided separately outside the robot control device 200 as described above.

Further, in the vision system depicted in FIG. 5, at least one of the image capturing device (camera) 1 and the object (workpiece) 5 is grasped by a movement controllable actuator, and the position of the camera 1 with respect to the workpiece 5 is adapted to be controlled to move. In other words, the image processing device 3 according to the present embodiment may be widely applied to various machines and robots in which at least one of the camera 1 and the workpiece 5 is grasped by the movement controllable actuator.

As depicted in FIG. 5, the image processing device 3, which is used to obtain spatial position information of the workpiece 5 based on image information from a camera 1 having a lens (not shown) for imaging the workpiece 5, includes a processing unit (arithmetic processing unit) 31 and a storage unit 32. Here, reference numeral 2 denotes a lighting device for irradiating light onto the workpiece 5. In this embodiment, the lighting device 2 is controlled by an image processing device 3 as will be described later. For example, the workpiece 5 may always be irradiated with a constant amount of light.

The processing unit 31 includes an aperture control unit 311, a focus control unit 312, a lighting control unit 313, a feature extraction unit 314, a position calculation unit 315 and an exposure control unit 316. The aperture control unit 311 controls an aperture of the lens of the camera 1 that captures the workpiece 5, and the focus control unit 312 controls a focus of the lens of the camera 1. The lighting control unit 313 controls an intensity of the light from the lighting device 2, that is, the intensity of the irradiation light emitted from the lighting device 2 that illuminates the workpiece 5.

The storage unit 32 stores an image processing program 320 to be executed by the processing unit 31. The image processing program 320 includes a feature storage unit (feature information) 321, a parameter storage unit (parameter information) 322 and an aperture storage unit (aperture information) 323. The feature storage unit 321 stores, for example, feature information of the workpiece 5 to be detected from image information of the workpiece 5 captured by the camera 1. The parameter storage unit 322 stores, for example, parameter information used in conversion equations for obtaining a spatial position of the workpiece 5 from focus position information (focus information) and image information. The aperture storage unit 323 stores, for example, the relationship (aperture information) between the distance between the workpiece 5 and the camera 1 (distance of the camera 1 with respect to the workpiece 5) and the aperture amount (aperture value).

The feature extraction unit 314 extracts feature information stored in the feature storage unit 321 from the image information of the workpiece 5 captured by the camera 1. The position calculation unit 315 calculates the spatial position of the workpiece 5 based on the image information of the workpiece 5 captured by the camera 1 and the parameters obtained from the parameter storage unit 322.

Here, for example, when the workpiece 5 and the camera 1 are at the first distance, the position calculation unit 315 reads parameters corresponding to the focus position of the lens adjusted and fixed by the focus control unit 312 from the parameter storage unit 322. Further, the position calculation unit 315 calculates the spatial position of the workpiece 5 from the first image at the first distance captured by the aperture control unit 311 with the aperture of the lens as the first aperture.

Note that, the parameters obtained when the workpiece 5 and the camera 1 are at the first distance are also used when the workpiece 5 and the camera 1 are at the second distance. That is, for example, when the workpiece 5 and the camera 1 are at the second distance, the position calculation unit 315 uses the same parameters as when the workpiece 5 and the camera 1 are at the first distance, and the aperture control unit 311 adjusts the aperture of the lens to the second distance. At this time, the aperture control unit 311 controls the aperture amount of the camera 1 by referring to the aperture information stored in the aperture storage unit 323.

Specifically, when moving the hand unit 110 closer to the workpiece 5 on the workbench 4 from a far distance, the aperture control unit 311 increases the aperture amount so as to focus the second distance workpiece 5 at the focused focus position at the time of the first distance to increase the depth of field. That is, when the first distance >the second distance, the aperture control unit 311 controls to enter the depth of field by increasing the aperture of the lens at the fixed focus position when the workpiece and the camera are at the first distance, so that the workpiece and the camera are focused on the workpiece 5 even at the second distance.

The exposure control unit 316 adjusts the exposure time (shutter speed) of the camera 1, and when the workpiece 5 and the camera 1 are at the second distance, the aperture is enlarged to deepen the depth of field and focus on the workpiece 5. Specifically, when the workpiece 5 and the camera 1 are at the second distance, and when the workpiece 5 and the camera 1 are at twice the aperture amount at the first distance, the exposure control unit 316 controls the exposure time to be four times that at the time of capturing the first image.

The lighting control unit 313 adjusts an intensity (amount of light) of the light emitted from the lighting device 2 and compensates, when the workpiece 5 and the camera 1 are at the second distance, a decrease in exposure corresponding to an increased amount of aperture to focus on the workpiece 5 by increasing the depth of field. Specifically, when the workpiece 5 and the camera 1 are at the second distance, during the aperture is doubled as compared to when the workpiece 5 and the camera 1 are at the first distance, the lighting control unit 313 controls the lighting device to control the intensity of the irradiation light from the lighting device 2 to be four times that when the first image is captured.

Note that, if there is a problem in increasing the exposure time, it may be preferable to increase the intensity of the irradiation light from the lighting device 2 by the lighting control unit 313 without increasing the exposure time of the camera 1 by the exposure control unit 316. On the other hand, when it is difficult to increase the intensity of the irradiation light from the lighting device 2, it may be preferable to increase the exposure time of the camera 1 by the exposure control unit 316 without increasing the intensity of the irradiation light from the lighting device 2 by the lighting control unit 313.

Furthermore, compensation of the exposure reduction performed when the workpiece 5 and the camera 1 are at the second distance is not limited to being performed by one of the exposure control unit 316 or the lighting control unit 313, but may be performed using both the exposure control unit 316 and the lighting control unit 313. At this time, the compensation of the exposure time by the exposure control unit 316 and the compensation of the exposure amount by the lighting control unit 313 may also be divided into predetermined ratios. Specifically, if it is necessary to narrow down to twice the squeeze amount of the first distance at the second distance, for example, it is also possible to control the exposure amount of the second image (intensity of irradiated light) to double that for the first image, while controlling the exposure time of the second image to double that for the first image.

Note that, the first distance and the second distance described above are not limited to the case where the first distance >the second distance, i.e., they are not limited to the case where the hand unit 110 to which the camera 1 or the like is attached is moved from a far distance to a near portion of the workpiece 5. Further, the image processing device of this example (vision system) may also be applied when the first distance=second distance, i.e., the case where the hand unit 110 to which the camera 1 or the like is attached is moved from a near distance to a far portion of the workpiece 5. Furthermore, the image processing device of this example, the case of the first distance <second distance, i.e., the hand unit 110 where the camera 1 or the like is attached, can also be applied when moving far from the vicinity of the workpiece 5.

Specifically, when the first distance=the second distance, the workpiece 5 may be focused on as it is even when the workpiece 5 and the camera 1 are at the second distance. Further, when the first distance <the second distance, the workpiece 5 may be focused even if the depth of field is made shallow when the workpiece 5 and the camera 1 are at the second distance. Here, by referring to the obtained aperture information, the aperture of the camera 1 may be reduced, and at least one of the exposure control unit 316 and the lighting control unit 313 may compensate (offset) the increase in exposure corresponding to the decrease in the aperture amount.

As described above, according to an example of the image processing device of the present embodiment, the focus position of the lens is fixed when the distance between the camera 1 and the workpiece 5 is both the first distance and the second distance. This makes it possible to calculate the spatial position information of the workpiece 5 from the image information using the same parameters for the first image captured at the first distance and the second image captured at the second distance. As a result, image processing for obtaining spatial position information of a workpiece based on image information may be performed in a short time with high accuracy. Note that, in the image processing device (vision system) according to the present embodiment, the camera 1 is not limited to an autofocus camera as long as it has a lens focusing function, and it is of course possible that a camera performs focusing manually.

FIG. 6 is a flowchart for explaining an example of processing of an image processing program executed by a processing unit (arithmetic processing unit) of the image processing device depicted in FIG. 5. Here, FIG. 6 explains a case where the hand unit 110 is previously taught to move from a far position to a near position of the workbench 4 (first distance >second distance), in the industrial robot system described with reference to FIG. 1. Note that the workpiece 5 is placed on the workbench 4, and the camera 1 and lighting device 2 are attached to the vicinity of the hand unit 110 of the industrial robot 100.

As depicted in FIG. 6, when the example of the processing of the image processing program is started (START), in step ST1, for example, the camera 1 (lighting device 2) attached to the vicinity of the hand unit 110 of the industrial robot 100 is moved to a position of a first distance from the workpiece 5. Here, a movement operation of the hand unit 110 to the position of the first distance from the workpiece 5 is performed based on a movement route previously taught by the robot control device 200.

Next, proceeding to step ST2, the focus control unit 312 adjusts and fixes a focus of the lens of the camera 1 to focus on the workpiece 5 at a position of the first distance. Further, in step ST3, the aperture control unit 311 adjusts an aperture of the lens of the camera 1 at a position of the first distance, and the process proceeds to step ST4.

In step ST4, a position conversion parameter corresponding to the first distance is obtained from the image and set in the parameter storage unit 322, and the process proceeds to step ST5, where the camera 1 captures the first image at the position of the first distance. do. Then, in step ST6, the first process is executed based on the first image.

As this first process, for example, based on the first image with a wide angle of view including the periphery of the workpiece 5, the parameters set in step ST4 and the conversion equations for converting the image information of the workpiece 5 into spatial position information is used to obtain the spatial position information of the workpiece 5. Then, the feature of the workpiece 5 read out from the feature storage unit 321 by the feature extraction unit 314 is applied to the obtained spatial position information of the workpiece 5, and the hand unit 100 is moved to a second distance position closer to the workpiece 5, for example. Calculation or modification of the movement route for moving 110 is performed.

Next, proceeding to step ST7, the hand unit 110 is moved, for example, based on the movement route calculated or corrected in step ST6. That is, the movement of the hand unit 110 in step ST7 is performed by correcting a pre-taught movement route based on the spatial position information of the workpiece 5 obtained in the first process in step ST6, for example. It may be moved to a position a second distance from the position. Note that the movement of the hand unit 110 in step ST7 may also be performed according to the pre-taught movement route regardless of the spatial position information of the workpiece 5 obtained by the first process in step ST6. These are appropriately selected according to, for example, the accuracy required for the system to which the industrial robot 200 is applied, the magnitude of the expected positional deviation of the workpiece 5, and the like.

Further, the process proceeds to step ST8, the aperture control unit 311 adjusts the aperture of the lens at the position of the second distance, and the process proceeds to step ST9. Here, in step ST8, a focus position set on the lens is adjusted to focus on the workpiece 5 at the position of the first distance, and the fixed position is used as it is.

That is, in step ST8, only the aperture of the lens is changed by the aperture control unit 311, and the workpiece 5 is adjusted so that it is within the depth of field at the position of the second distance (so that it is in focus). The compensation for the exposure reduction performed when the workpiece 5 and the camera 1 are at the second distance may be performed by one of the exposure control unit 316 or the lighting control unit 313, but it is as described above that may be performed using both the exposure control unit 316 and the lighting control unit 313.

In step ST9, at the second distance position, for example, a second image with an angle of view in which the workpiece 5 occupies most of the screen is captured. Here, since the focus position of the lens is fixed, the parameters used when obtaining the spatial position information of the workpiece 5 from the image information of the second image may be used as the same as the spatial position information of the workpiece 5 from the image information of the first image.

That is, at the position of the second distance, it is not necessary to obtain new parameters, and the processing time for obtaining the spatial position of the workpiece may be shortened. Further, even at the second distance, the focus position of the lens is fixed at the first distance, and therefore, it is also possible to improve the accuracy of converting the spatial position information of the workpiece from.

Furthermore, in step ST10, for example, the spatial position information of the workpiece 5 is calculated using the same parameters as those used for processing the first image, based on the image information of the second image in which the workpiece 5 is enlarged, and the process is terminated (END).

In the above-described flowchart, for example, as the process of step ST7, the robot is moved to the second position according to the pre-taught movement route, and in step 10, the first process based on the first image and the second process based on the second image 2 may also be performed. Specifically, when the first distance is =the second distance, the first image and the second image are, for example, images by capturing the workpiece 5 from different angles, by calculating the spatial position of the workpiece 1 by processing such two images, it is possible to improve the calculation accuracy.

Furthermore, the spatial position of the workpiece 1 may also be calculated by processing the first and second images at different positions and different angles. Further, the image to be imaged is not limited to two of the first image and the second image, and the same processing can be performed to obtain the spatial position of the workpiece 5 by imaging the third image, the fourth image, and . . . . It is needless to say that in order to obtain the position (spatial position information of the object) of the workpiece 5 from the imaged one or more images (image information of the object), for example, various known image processing techniques may be applied and performed.

Note that the image processing program or application software described above may be recorded in a computer-readable non-temporary recording medium or non-volatile semiconductor storage device and provided, or may be provided via wired or wireless communication. Here, as a computer-readable non-temporary recording medium, for example, an optical disk such as a CD-ROM (Compact Disc Read Only Memory) or a DVD-ROM, or a hard disk device, and the like may be considered. Further, a PROM (Programmable Read Only Memory), a Flash Memory (registered trademark), and the like are conceivable as nonvolatile semiconductor memory devices. In addition, the distribution from the server device may be provided via a wired or wireless WAN (Wide Area Network), LAN (Local Area Network), or via the Internet.

As described in detail above, according to the image processing device, vision system, and image processing program according to the present embodiment, image processing for obtaining spatial position information of an object based on image information may be performed in a short time with high accuracy.

Although the embodiments of the present disclosure have been described in detail, the present disclosure is not limited to the individual embodiments described above. These embodiments include various additions and replacements without departing from the gist of the invention, or without departing from the idea and spirit of the invention derived from the content described in the claims and equivalents thereof, modification, partial deletion, and the like are possible. For example, in the above-described embodiments, the order of each operation and the order of each process are shown as an example, and are not limited to these. The same applies when numerical values or equations are used in the description of the above-described embodiments.

1. An image processing device for obtaining spatial position information of an object based on image information output from an image capturing device including a lens configured to capture an image of the object, comprising:
an aperture control unit configured to control an aperture of the lens, wherein
a focus position of the lens is adjusted and fixed, the aperture control unit sets the aperture of the lens to a first aperture, and the image capturing device captures the object to obtain a first image, when a distance from the image capturing device to the object is a first distance; and
the aperture control unit sets the aperture of the lens to a second aperture, and the image capturing device captures the object to obtain a second image, when the distance from the image capturing device to the object is a second distance.

2. The image processing device according to claim 1, further comprising:
a focus control unit configured to control the focus position of the lens, wherein
the focus control unit adjusts and fixes the focus position of the lens, when the distance from the image capturing device to the object is the first distance.

3. The image processing device according to claim 1, further comprising:
a storage unit configured to store an image processing program for obtaining the spatial position information of the object with reference to the first image and the second image.

4. The image processing device according to claim 1, further comprising:
an exposure control unit configured to control an exposure amount of the image capturing device, wherein
the exposure control unit controls the exposure amount of the image capturing device based on the second aperture of the lens, when the focus position of the lens is at the second distance from the image capturing device to the object.

5. The image processing device according to claim 1, further comprising:
a lighting control unit configured to control an intensity of an irradiation light output from a lighting device provided in a vicinity of the image capturing device,
the lighting control unit control the intensity of the irradiation light output from the lighting device based on the second aperture of the lens, when the focus position of the lens is at the second distance from the image capturing device to the object.

6. The image processing device according to claim 1, wherein
at least one of the image capturing device and the object is grasped by a movement controllable actuator.

7. The image processing device according to claim 1, wherein
a length of the first distance is longer than a length of the second distance, and
a value of the first aperture is smaller than a value of the second aperture.

8. The image processing device according to claim 1, wherein
the second distance is obtained with reference to the first image, and
the spatial position information of the object is obtained with reference to the second image.

9. The image processing device according to claim 1, wherein
the spatial position information of the object is obtained with reference to the first image and the second image.

10. The image processing device according to claim 1, wherein
the second aperture is determined with reference to the first distance and the second distance, and previously generated aperture information.

11. A vision system comprising:
the image processing device according to claim 1; and
the image capturing device.

12. A computer readable non-transitory tangible medium for storing an image processing program of an image processing device for obtaining spatial position information of an object based on image information output from an image capturing device including a lens configured to capture an image of the object, the image processing program causing an arithmetic processing unit to execute:
adjusting and fixing a focus position of the lens, setting the aperture of the lens to a first aperture, and capturing the object to obtain a first image, when a distance from the image capturing device to the object is a first distance, and
setting the aperture of the lens to a second aperture, and capturing the object to obtain a second image, when the distance from the image capturing device to the object is a second distance.
